(19) United States
(12) Patent Application Publication
(10) Pub. No.: US 2015/0055939 A1
(43) Pub. Date: Feb. 26, 2015

(54) DATA ARCHIVAL ON FILM

(71) Applicant: Markus Loeffler, Altadena, CA (US)

(72) Inventor: Markus Loeffler, Altadena, CA (US)

(73) Assignee: THOMSON LICENSING, Issy de Moulineaux (FR)

(21) Appl. No.: 14/384,079

(22) PCT Filed: Mar. 14, 2012
(86) PCT No.: PCT/US2012/028985

§ 371 Date: Sep. 9, 2014

(51) Int. Cl. H04N 5/84; G11B 7/0045; G11B 20/00; H04N 9/80

(52) U.S. Cl. CPC H04N 5/843; H04N 9/80; G11B 7/0045; G11B 20/00007; G11B 2020/00072
USPC 386/300

(57) ABSTRACT

A method for archiving a binary data bit stream onto at least one frame of film commences by encoding the binary bit stream using a prescribed set of gray levels. Thereafter, a successive one of a set of sub-frames within the at least one frame is aligned with a beam. The beam scans each successive sub-frame to expose each of a successive set of data cells within that sub-frame with light at a gray level corresponding each of a set of bits to be written within each successive data cell.

### TECHNICAL FIELD

This invention relates to a technique for archiving binary data on film.

### BACKGROUND ART

Archival of information and particularly binary data remains, vitally important to many entities, including government and industry. The archival period will typically dictate the archival medium. For example, short-term storage of binary data for months or even a few years can occur using magnetic or optical media. However, after a few years, magnetic and optical media can degrade, making reliable retrieval of data difficult. Optical film, when stored under appropriate conditions, can last for several hundred years, making optical film a useful medium for long-term data archival.

While techniques presently exist for archiving binary data on optical film, such techniques typically make use of microfilm equipment well known in the art. However, the motion picture industry would like to make use of existing equipment, such as film scanners and laser recorders, to carry out data archival. To date, no reliable technique exists that enables archival of binary data onto film with low data loss using existing film scanning and laser recording equipment.

### BRIEF SUMMARY OF THE INVENTION

Briefly, in accordance with a preferred embodiment of the present principles, a method for archiving a binary data bit stream onto at least one frame of film commences by encoding the binary bit stream using a prescribed set of gray levels. Thereafter, a successive one of a set of sub-frames within the at least one frame is aligned with a light beam. The light beam scans each successive sub-frame to expose each of a successive set of data cells within that sub-frame with light at a gray level corresponding each of a set of bits to be written within each successive data cell.

### BRIEF DESCRIPTION OF THE DRAWINGS

FIG. 1 depicts a block schematic diagram of an apparatus for exposing film to write a binary data bit stream onto the film to archive the data in accordance with the present principles;

FIG. 2 shows a frame of the film of FIG. 1 divided into sub-frames; and

FIG. 3 shows a pair of the sub-frames of FIG. 2, each with alignment indicators for enabling alignment of each sub-frame during exposure of the film to achieve data archival.

### DETAILED DESCRIPTION

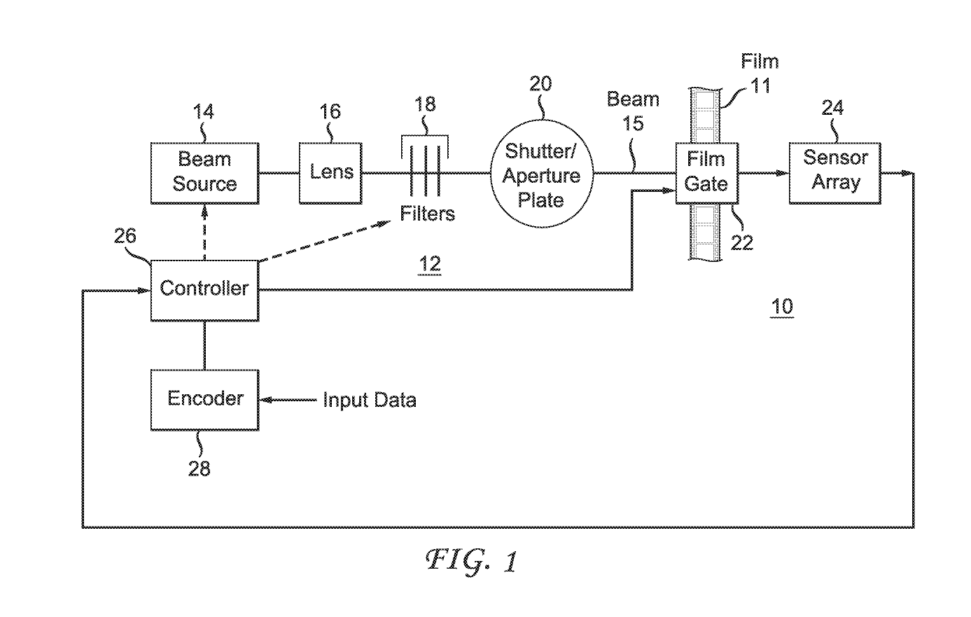

FIG. 1 depicts a block schematic diagram of an apparatus 10 for recording a binary data bit stream onto a negative film 11 film to achieve data in accordance with the present principles. In its simplest form, the recording apparatus 10 includes a beam source 14 that produces a collimated beam 15. The beam source 14 can take different forms, including, but not limited a source of incandescent light, a laser, or a CRT beam for example. One or more lenses 16 focus the beam 15 emanating from the beam source 14 onto more or more filters 18 and into a shutter plate 20 that controls the light exposing the film 11 traveling through a film gate 22 in optical registration with the shutter plate. A motor driven supply and take-up reel (not shown) operate in combination to advance each frame of the film through the film gate 22 for exposure by the beam 15.

The recording apparatus 10 of FIG. 1 can include a sensor array 24 situated within the optical path of the beam 15 passing through the film held by the film grate 22. The sensor array 24 converts incident light that passes through the film print into electrical signals. Using the output signals of the sensor array 24, a controller 26 connected to the sensor array can detect alignment indicia on the film 11 as described hereinafter to enable alignment of the film in the film gate 22. Typically, the controller 26 takes the form of a computer or microprocessor.

To assure high resolution, the collimated light beam 15 typically has a very narrow beam width and thus illuminates only a very small area within a given frame of the film. In order to illuminate successive areas of each film frame, the beam 15 scans the frame. To achieve such scanning, the controller 26 controls the displacement of the film gate 22 relative to the beam 15. Note that beam scanning could also occur by precisely displacing the beam 15 relative to the film grate 22.

To accomplish data archival in accordance with a preferred embodiment of the present principles, while overcoming spatial distortion and noise levels usually inherent in reading the film 11 by a conventional film scanner, the binary data stream destined for archival undergoes encoding via an encoder 28 associated with the recording apparatus 10 of FIG. 1. The encoder 28 makes use of using an error correction coding technique during coding to reduce errors, especially during reading of the film to retrieve the data. In practice, the encoder 28 encodes the incoming binary data bit stream using the well-known Golay coding technique, although other coding techniques that provide error correction could prove equally useful.

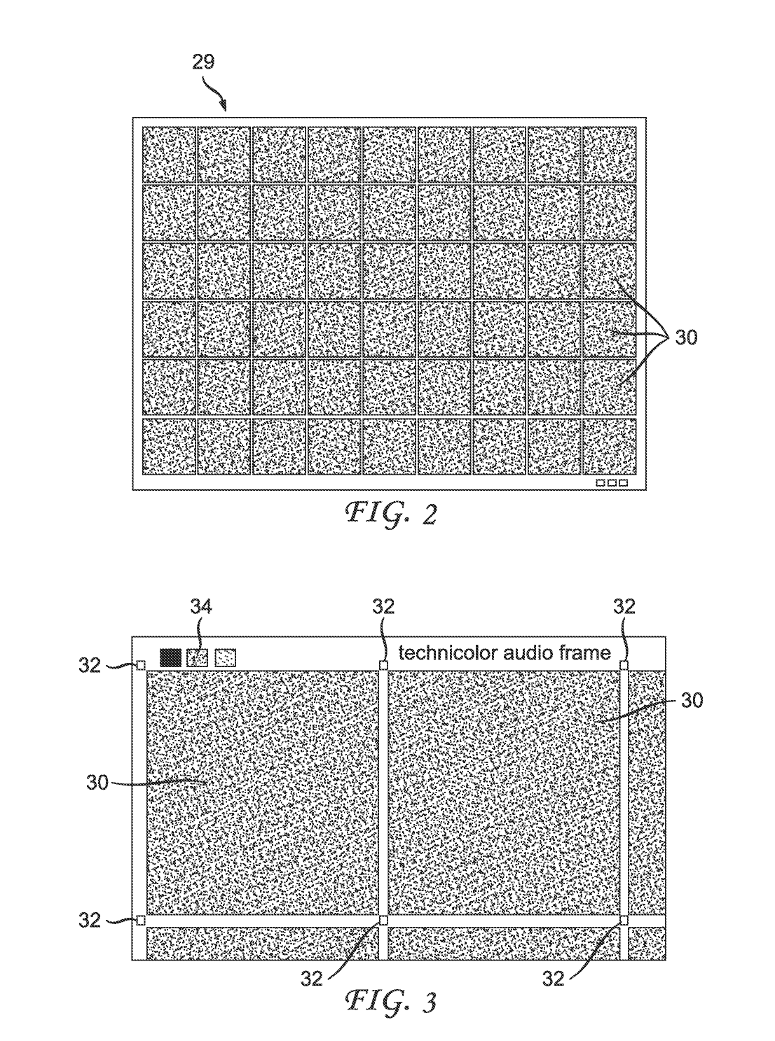

The encoding performed by encoder 28 make uses a set of gray levels corresponding the gray levels associated with exposure of the film 11 to write the encoded binary data stream onto the film. In practice, the beam 15 of FIG. 1 writes the binary data stream onto the film occurs by writing a predetermined number of data bits into each of a plurality of data cells within a given film frame 29 shown in FIG. 2. In practice, each data cell stores two bits of data so four separate gray levels become necessary. In the preferred embodiment, the four gray levels comprise 0, 33%, 66%, and 100% white although other levels are possible. Choosing two data bits per data cell represents a good compromise between the increased data capacity obtained by increasing the number of bits per data cell, and the difficulty incurred by trying to distinguish among a large number of different gray levels needed to write a large number of bits.

Most film print recorder for recording images onto optical film make use of a very bright beam. However, without adjustment, the use of such bright light to write data can also illuminate areas (data cells) adjacent to those intended for writing. Therefore, reducing the light level of the beam 15 by 60% from the value traditionally used to record images greatly reduces the likelihood of writing data to adjacent areas.

The controller 26 of FIG. 1 receives the encoded data from the encoder 28. In accordance with the corresponding gray level associated with the coding of each bit in the encoded bit stream, the controller 26 controls the gray level of the beam 15 exposing the film 11 by controlling one or both of the beam source 14 and/or the filters 18, all of FIG. 1. In addition to or in place of controlling the beam source 14 and/or the filters 18, the controller 28 could control the shutter associated with the shutter plate 20. Further, the controller serves to control displacement of the film gate 22 to both align the film 22 relative to the beam 15 as well as to scan the beam across the frame of the film exposed through the film gate to the light beam.

Once the film 11 has undergone exposure in the manner discussed above, the read-back of data on the film can occur using a convention film scanner (not shown). The use of a conventional film scanner to read-back data can incur certain difficulties that the archival technique of the present principals advantageously overcomes in the following manner. All film scanners typically introduce some spatial distortion. Reduction of such spatial distortion can occur by splitting each frame of the film into smaller areas (sub-frames) during exposure to write data. As depicted in the illustrative embodiment of FIG. 2, each film frame 29 undergoes division into a matrix array of 9×6 sub-frames prior to exposure, each sub-frame identified by reference numeral 30. The division of each film frame 29 can yield a smaller or larger number of sub-frames without departing from the present principles. The division of each frame the array of 9×6 sub-frames 30 represents a good compromise between having a large number of smaller areas to avoid distortion, and while reducing the effort associated with aligning such a large number of sub-frames. A color film, such as Kodak color film 2254, has a frame comprised of 2048×1556 pixels. Splitting each frame of such film into an array of 9×6 sub-frames 30 as depicted in FIG. 2 yields 218×244 pixels per sub-frame.

Referring to FIG. 3, to align each sub-frame 30 during exposure and subsequent reading, each sub-frame has four alignment indicia 32, each in the form of a dot located adjacent to a corresponding one of the corners of each sub-frame. Adjacent sub-frames 30 in FIG. 3 share the same alignment dots 32 at their adjacent corners. Locating the alignment dots 32 of FIG. 3 enables precise alignment of each sub-frame 30.

Given the relatively small size of each sub-frame 30 of FIGS. 2 and 3, an accuracy level of a hundredth of a pixel position become necessary. To achieve such precision, the brightness center of each alignment dot 32 of FIG. 3 is established using sub-pixel interpolation.

Reading back data line by line inside a sub-frame using a conventional scan line algorithm employed by a film scanner requires a nearly perfectly rectified area. In practice, the film scanner can perform bi-linear coordinate interpolation, which has proven successful to align the film to accomplish scanning for data retrieval. In practice, a single data-cell has a size of 2×2 pixels, so accurate alignment typically necessitates establishing the theoretical center pixel of that 2×2 pixel data cell. For this reason, the film scanner will make use of bilinear interpolation to acquire the resulting cell value as discussed.

As part of the process of retrieving data, the film scanner will map the light value read from each data cell to one of the four possible gray values (0, 33%, 66%, and 100%). Each frame contains a four-gray level histogram field 34 in the top left corner as depicted in FIG. 2. These fields in the histogram 34 undergo analysis to produce an average gray value used to map a value returned after scanning the bits in each data-cell.

In practice, most film scanners provide separate red, green, and blue channel outputs, indicative of the red, green, and blue light intensities, respectively, measured during typically scanning of a color positive print film. For data retrieval, the green channel affords the sharpest resolution with current recording and color film technologies. Thus, the red and blue channel data can be discarded with no adverse effect.

The foregoing describes a technique for archiving data on film. Although the data archival process has been described using a film scanner, a laser film recorder or similar such device could serve equally useful to expose film to write data thereon in accordance with the present principles.

1. A method for archiving a binary data bit stream onto at least one frame of film, comprising the steps of
encoding the binary bit stream using a prescribed set of gray levels;
aligning, a successive one of a set of sub-frames within the at least one frame with a light beam; and
scanning the light beam scans across each successive sub-frame to expose each of a successive set of data cells within that sub-frame with light at a gray level corresponding each of a set of bits to be written within each successive data cell.

2. The method according to claim 1 wherein the encoding uses four gray levels.

3. The method according to claim 2 wherein the four gray levels comprise 0%, 33%, 66%, and 100%, respectively.

4. The method according to claim 1 wherein the step of aligning each sub-frame includes the step of locating each of a set of alignment indicia, each located adjacent to a corresponding sub-frame corner.

5. The method according to claim 1 wherein the each sub-frame is aligned within one one-hundredth of a pixel.

6. The method according to claim 4 wherein each alignment indicia is located using bilinear interpolation.

7. Apparatus for archiving a binary data bit stream onto at least one frame of film, comprising,
an encoder for encoding a binary bit stream using a prescribed set of gray levels;
a beam source for producing a collimated;
a film gate for guiding, a successive frame of the film in optical registration with the light beam; and
a controller for controlling displacement of the beam relative to the film to (a) align a successive one of a set of sub-frames within the at least one frame with a light beam; and (b) scan the light beam scans across each successive sub-frame to expose each of a successive set of data cells within that sub-frame with light at a gray level corresponding each of a set of bits to be written within each successive data cell.

8. The apparatus according to claim 7 wherein the encoder encodes the binary data bit stream using four gray levels.

9. The apparatus according to claim 8 wherein the four gray levels comprise 0%, 33%, 66%, and 100%, respectively.

10. The apparatus according to claim 7 further including a sensor array coupled to the controller for detecting each of a set of alignment indicia, each located adjacent to a corresponding sub-frame corner to enable the controller to align a successive one of a set of sub-frames within the at least one frame with the light beam.

11. Apparatus for method for archiving a binary data bit stream onto at least one frame of film, comprising:
means for encoding the binary bit stream using a prescribed set of gray levels;
means for aligning, a successive one of a set of sub-frames within the at least one frame with a beam; and
means for scanning the beam scans across each successive sub-frame to expose each of a successive set of data cells within that sub-frame with light at a gray level corresponding each of a set of bits to be written within each successive data cell.
